(19) United States
(12) Patent Application Publication
(10) Pub. No.: US 2015/0186256 A1
(43) Pub. Date: Jul. 2, 2015

(54) PROVIDING VIRTUAL STORAGE POOLS FOR TARGET APPLICATIONS

(71) Applicant: EMC Corporation, Hopkinton, MA (US)

(72) Inventors: Yu Cao, Beijing (CN); Baoyao Zhou, Beijing (CN); Xiaoyan Guo, Beijing (CN); Jun Tao, Shanghai (CN); Caihua Yin, Shanghai (CN); Zhihong Bu, Shanghai (CN); Chao Chen, Shanghai (CN)

(21) Appl. No.: 14/573,793

(22) Filed: Dec. 17, 2014

(30) Foreign Application Priority Data
Dec. 27, 2013 (CN) 201310755994.3

(51) Int. Cl. G06F 12/02

(52) U.S. Cl. CPC G06F 12/023; G06F 2212/1016; G06F 2212/152

(57) ABSTRACT

The present disclosure relates to a method and system for providing a virtual storage pool set for a target application by receiving performance requirements associated with the target application; and providing a virtual storage pool set for the target application according to the performance requirements and on the basis of storage capabilities of physical storage resources, the virtual storage pool set comprising one or more virtual storage pools. By means of various embodiments of the present disclosure, virtual storage pools can be provided for the target application efficiently and flexibly and can be adjusted dynamically.

This Application claims priority from Provisional Application Ser. No. CN201310775994.3 filed on Dec. 27, 2013 entitled “METHOD AND SYSTEM FOR PROVIDING VIRTUAL STORAGE POOLS TO TARGET APPLICATIONS,” the content and teachings of which are hereby incorporated by reference in their entirety.

### FIELD OF THE INVENTION

Embodiments of the present disclosure relate to the field of storage, and more particularly, towards providing a virtual storage pool for a target application.

### BACKGROUND OF THE INVENTION

With the constant developments in the field of computer technology, newer storage techniques are increasingly finding importance. For example, software-Defined Storage (SDS) platforms (like EMC® ViPR™) provide capabilities to abstract physical storage arrays, so that physical storage capabilities can be abstracted into a couple of single pools of virtual storage for target applications. Based thereon, storage administrators then create one or more virtual storage pools (VSP) with respect to unique requirements of the various target applications. For example, a transactional workload would subscribe to a virtual storage pool that features the characteristics of a high-performance block store such as EMC® VMAX®. A cloud application such as an online and content sharing file would subscribe to a virtual storage pool that features the characteristics of a distributed object or file-based storage cloud.

In traditional VSP techniques, however, management of virtual storage pools (e.g. in ViPR) to a large extent relies on the storage administrator, thereby leading to an extremely low efficiency. In addition, the management of virtual storage pools in reliance on administrator operations is largely affected by the domain expertise, experience and even working status of the administrator.

Besides, the virtual storage pools that are provided are almost static in nature. Once created, a virtual storage pool's configuration and physical resource allocation usually remain unchanged throughout its lifecycle, which makes it impossible to efficiently and effectively react to incidents that can occur at runtime.

### SUMMARY OF THE INVENTION

To this end, the present disclosure provides a technique for providing a virtual storage pool for a target application.

According to an embodiment of the present disclosure, there is provided an apparatus and a method for providing a virtual storage pool for a target application, which includes receiving performance requirements associated with the target application; and providing a virtual storage pool set for the target application according to the performance requirements and on the basis of storage capabilities of physical storage resources, the virtual storage pool set comprising one or more virtual storage pools.

According to an optional embodiment of the present disclosure, the providing a virtual storage pool set for the target application according to the performance requirements and on the basis of storage capabilities of physical storage resources includes building a performance prediction model on the basis of historical data of one or more historical target applications, the historical data comprising a virtual storage pool set that is provided for each of the one or more historical target applications, as well as corresponding performance obtained; generating one or more alternative virtual storage pool sets for the target application according to the performance requirements and on the basis of the storage capabilities of the physical storage resources; respectively predicting performance of the one or more alternative virtual storage pool sets by using the performance prediction model; and selecting, on the basis of the prediction, one alternative virtual storage pool set from the one or more alternative virtual storage pool sets so as to be provided to the target application.

According to an optional embodiment of the present disclosure, the method further includes monitoring status of one or more virtual storage pools in the virtual storage pool set; detecting runtime events related to one or more virtual storage pools in the virtual storage pool set; and adjusting, on the basis of the status and the runtime events, the virtual storage pool set provided for the target application.

According to an optional embodiment of the present disclosure, the status comprises one or more of: Quality of Service of one or more virtual storage pools in the virtual storage pool set for the target application, performance metrics of one or more virtual storage pools in the virtual storage pool set, physical resource utilization of one or more virtual storage pools in the virtual storage pool set, interactions and contentions between multiple virtual storage pools.

According to an optional embodiment of the present disclosure, the runtime events comprise changes of the target application and/or changes of the physical storage resources.

According to an optional embodiment of the present disclosure, the step of adjusting the virtual storage pool set provided for the target application includes creating a new virtual storage pool in the virtual storage pool set, reclaiming an inactive virtual storage pool in the virtual storage pool set, or migrating workloads between multiple virtual storage pools in the virtual storage pool set.

According to an optional embodiment of the present disclosure, the adjustment to the virtual storage pool set is further based on input from a user.

According to an optional embodiment of the present disclosure, the performance requirements includes one or more of parameter such as capacity, cost, latency and a number of input/output operations per second (IOPs).

According to an embodiment of the present disclosure, the apparatus can includes one or more additional modules configured to execute the method steps discussed above, wherein the module may be part of the system, i.e., integrated into the system or may be a standalone module that can communicate with the apparatus to perform the method steps.

### BRIEF DESCRIPTION OF THE DRAWINGS

FIG. 1 illustrates an exemplary flowchart of a method for providing a virtual storage pool for a target application according to one embodiment of the present disclosure;

FIG. 2 illustrates one exemplary implementation of providing a VSP set for a target application according to one embodiment of the present disclosure;

FIG. 3 illustrates an exemplary flowchart of a method for adjusting provided VSPs according to one optional embodiment of the present disclosure;

FIG. 4 illustrates an exemplary block diagram of a system/apparatus 400 for providing a virtual storage pool set for a target application according to one embodiment of the present disclosure; and

FIG. 5 illustrates an exemplary block diagram of a computer system 500 which is applicable to implement the embodiments of the present disclosure.

Note that the flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### DETAILED DESCRIPTION OF EMBODIMENTS

With reference to several exemplary embodiments shown in the accompanying drawings, description is presented below to the principle and spirit of the present disclosure. It should be understood that these embodiments are provided only to enable those skilled in the art to better understand and further implement the present invention, rather than limiting the scope of the present invention in any manner.

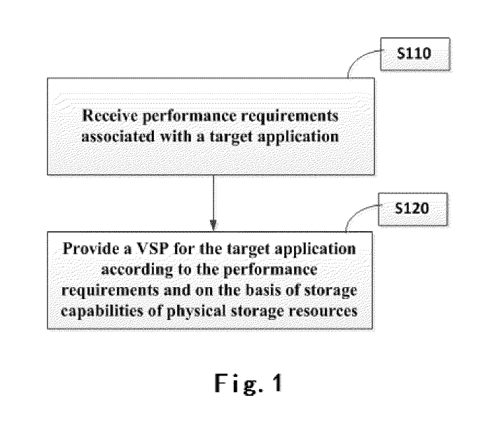

Reference is made to FIG. 1, which illustrates a flowchart of a method for providing a virtual storage pool for a target application according to one embodiment of the present invention. As shown in FIG. 1, the method first proceeds to step S110 where performance requirements associated with the target application are received. It is well known to one skilled in the art that virtualization storage technique enables to provide VSP for a set of target application workloads (hereinafter referred to as “target applications”). Usually, each target application has performance requirements specified by a set of Service-Level Objectives (SLOs) (hereinafter also referred to as “parameters”), such as capacity, cost, latency and a number of input/output operations per second (IOPs).

Next the method proceeds to step S120 where a VSP set is provided for the target application on the basis of storage capabilities of physical storage resources according to the performance requirements, wherein the VSP set includes one or more VSPs. It should be understood that the virtual storage technique is built on the basis of physical storage resources like physical storage arrays, so to provide a VSP set for the target application, and storage capabilities of various physical storage arrays should be taken into consideration. In practice, since these storage capabilities are usually associated with various storage arrays in the form of technical specification (usually machine-readable), they can be obtained easily.

Optionally, a mapping relationship between the target application and all VSPs in the provided VSP set may be recorded; optionally, a mapping relationship between one or more VSPs involved in the provided VSP set and corresponding physical storage resources may be recorded for purposes of the follow-up, lookup, reference and so on.

In addition, the method further includes an optional step: receiving the user's input as adjustment to the VSP set provided for the target application (not shown in the figure). This indicates that the method for providing VSP for a target application according to the embodiment of the present disclosure can take users' demands or recommendations into consideration wherever it is necessary.

The method for providing VSP for a target application depicted with reference to FIG. 1 takes into consideration performance requirements of the target application and actual physical storage resources, provides VSP for the target application, preferably automatically, and in a fine-grained way, thereby increasing the overall efficiency.

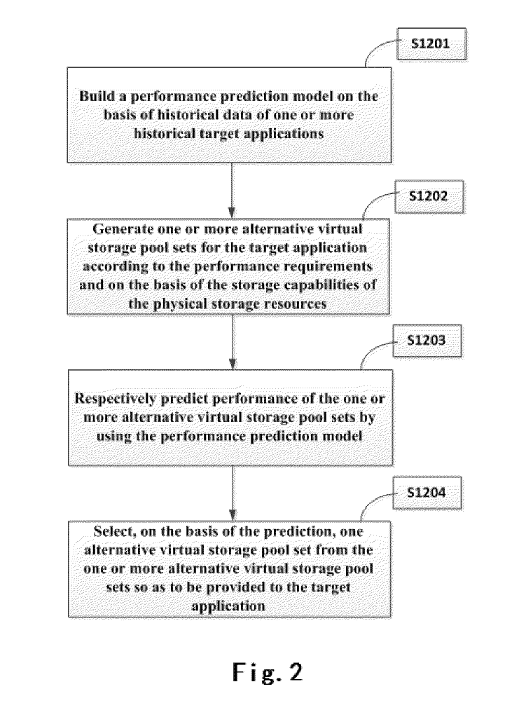

According to one optional embodiment of the present disclosure, step S120 as shown in FIG. 1 may be implemented in a way as shown in FIG. 2. As illustrated in FIG. 2, step S120 may comprise step S1201 where a performance prediction model is built on the basis of historical data of one or more target applications, preferably historical target applications. The historical data mentioned here may comprise a VSP set that is provided for each of the one or more historical target applications, and corresponding performance obtained. That is, the method for providing VSP according to this optional embodiment continuously collects information of historical VSPs on their configurations and corresponding performance while providing specific target applications. Based on the learning of these historical information, a performance prediction model (also referred to as cost model) capable of predicting VSP performance may be built. In a specific implementation, the learning may be conducted by various statistical techniques (like linear regression or the likes) so as to obtain the performance prediction model.

The method then proceeds to step S1202 where one or more alternative virtual storage pool sets are generated for the target application on the basis of storage capabilities of the physical storage resources according to the performance requirements. It should be understood that there could exist a variety of VSP set configurations for selection with respect to a specific target application according to specific performance requirements and storage capabilities of physical storage resources. In this specification, possible various VSP sets are referred to as alternative VSP sets in order to distinguish from the VSP set that is finally provided to the target application.

Next in step S1203, performance of the one or more alternative virtual storage pool sets is predicted using the performance prediction model, respectively; and in step S1204, one alternative virtual storage pool set is selected from the one or more alternative virtual storage pool sets in order to be provided to the target application, on the basis of the prediction. For example, the optimal set of initial VSPs may be found by enumerating (with certain algorithms like dynamic programming, linear programming and Hill-Climb) different alternative VSP set and configuration combinations, and then comparing their performance utilizing the performance prediction model.

With reference to FIG. 2, illustration has been presented to one exemplary implementation of providing a VSP set for a target application according to the embodiment of the present disclosure. According to the implementation, a VSP set with optimal performance may be provided to the target application so as to further improve the efficiency.

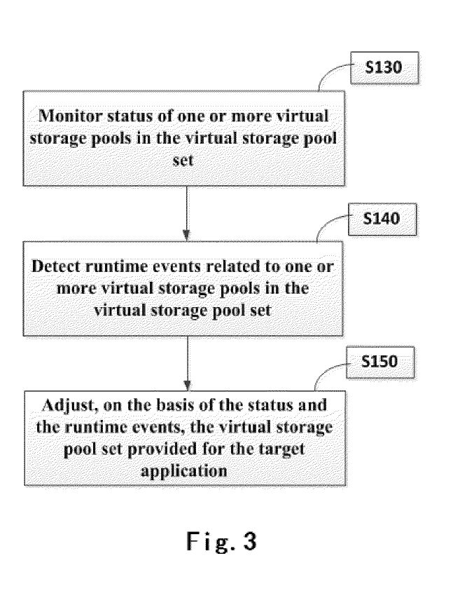

FIG. 3 illustrates a flowchart of a method for adjusting the provided VSP according to one optional embodiment of the present disclosure. The method for providing VSP for a target application according to the present disclosure allows to be adjusted dynamically after providing a VSP set to the target application. Specifically, at the runtime, there can be various incidents which may eventually result in application SLO violation or suboptimal performance, such as:

1) changes from application workloads, e.g. workload shift and SLO shift;
2) VSP resource contention (e.g. network bandwidth, memory and cache) with other VSPs;
3) VSP storage resource shortage or underutilization;
4) underlying physical storage resource changes, e.g. storage array failures.

In response to these above mentioned incidents, the method for managing VSP according to the embodiment of the present disclosure will dynamically adjust the set and the configurations of active VSPs, as well as dynamically adjust the workload for each application of the VSP to be subscribed to. For example, when a new physical storage array joins, it will be immediately allocated to an existing or newly created virtual storage pool; when a virtual storage pool is short of physical resources to serve its application workloads, and it will obtain additional resources from other virtual storage pools whose loads are low, or some of its application workloads may be migrated to other virtual storage pools. Such a runtime VSP adjustment and workload migration procedure may be conducted as illustrated by FIG. 3.

In step S130, status of one or more virtual storage pools in the virtual storage pool set is monitored. At runtime, statuses of VSPs that are live (alive) will be monitored for information like the QoS of VSPs for subscribing workloads, the VSP performance metrics, the physical resource utilization of VSPs, the interactions and contentions between VSPs.

In step S140, runtime events related to one or more virtual storage pools in the virtual storage pool set are detected. The runtime events include, for example, changes of the target application and/or changes of physical storage resources. Specifically, at runtime, various system incidents relevant to VSPs can be detected and reported, especially changes of the running workload set and underlying physical (storage) resources, e.g. newly joined physical storage arrays/pools.

Then in step S150, the virtual storage pool set provided for the target application is adjusted based on the status and runtime events. Specifically, at runtime, physical resources will be dynamically scheduled and reallocated among VSPs, new and deactivate deprecated VSPs created, and workloads migrated between different VSPs.

In an optional implementation, both the VSP status monitoring and runtime event detection may be continuous, i.e., runtime VSP status and runtime event information may be continuously collected. As another alternative, information on the VSP status may be, for example, periodically pushed for adjustment, and information on runtime events is preferably pushed as soon as it is detected, so as to learn in real time information such as changes involving hardware resources.

Also note that any adjustment to the VSP set can consider the user's suggestions/inputs, i.e., based on an adjustment made by a user, to control VSPs provided for the target application more flexibly. The user, therefore, will make adjustments on these VSPs and/or their detailed physical resource allocations and configurations, according to his knowledge, practices or other demands.

In addition, those skilled in the art should understand that during implementation, step S150 may be, by means of example, implemented via the step of making an adjustment decision on the basis of the monitored status and the monitored runtime events and the step of execution according to the made adjustment decision. In this case, after the adjustment decision is made, input from the user may be received, the adjustment decision is altered according to the input from the user, and then the altered adjustment decision is executed. The user may alter a decision that has previously been made on the basis of the VSP status and runtime events. However, those skilled in the art should further understand this implementation is merely for illustration; and in practice, step S150 may be completed using either more or less number of steps, and receiving input from the user may be implemented at any moment before making an adjustment. Various practices are only intended for a discussion on the method's implementation sphere and are not limiting the spirit and essence of the present disclosure.

In general, the method shown with reference to FIG. 3 an analytics engine can obtain relevant information by continuously monitoring VSP status and detecting runtime incidents during runtime, then make optimization decisions on the creation, deprecation and adjustment of VSPs as well as on the workload migrations on the basis of these parameters, and thus provide to each workload a VSP set that not only meets detailed requirements but optimizes overall system performance.

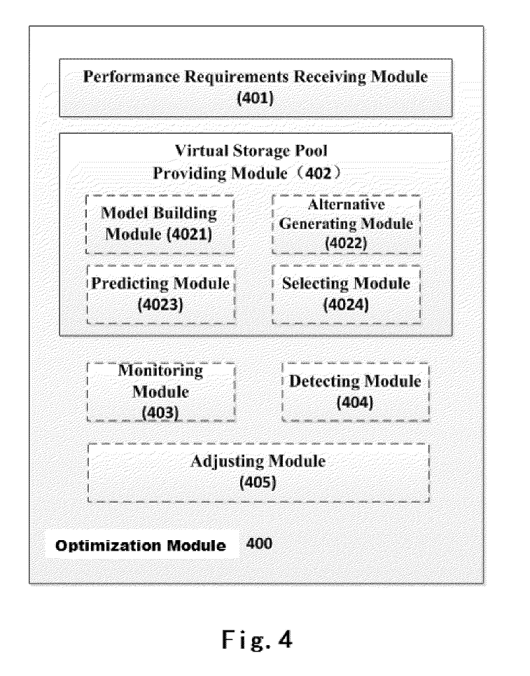

FIG. 4 illustrates a block diagram of a system/apparatus 400 for providing a virtual storage pool for a target application according to one embodiment of the present disclosure. As shown in this figure, system 400 includes performance requirements receiving module 401 configured to receive performance requirements associated with the target application; and virtual storage pool providing module 402 configured to provide a virtual storage pool set for the target application according to the performance requirements and on the basis of storage capabilities of physical storage resources, the virtual storage pool set comprising one or more virtual storage pools. Requirement receiving module 401 and virtual storage pool providing module 402, can be combined into a single module, for example an optimization module 400, wherein the single module is configured to perform the tasks of the Requirement receiving module 401 and virtual storage pool providing module 402.

According to an optional embodiment of the present disclosure, virtual storage pool providing module 402 further includes model building module 4021 configured to build a performance prediction model on the basis of historical data of one or more historical target applications, the historical data comprising a virtual storage pool set that is provided for each of the one or more historical target applications, as well as corresponding performance obtained; alternative generating module 4022 configured to generate one or more alternative virtual storage pool sets for the target application according to the performance requirements and on the basis of the storage capabilities of the physical storage resources; predicting module 4023 configured to respectively predict performance of the one or more alternative virtual storage pool sets by using the performance prediction model; and selecting module 4024 configured to select, on the basis of the prediction, one alternative virtual storage pool set from the one or more alternative virtual storage pool sets so as to be provided to the target application. Each of these sub-modules model building model 4021, alternative generating module 4022, predicting module 4023 and selecting module 4024, can be combined into the optimization module 400, wherein the optimization module is configured to perform the tasks of these sub-modules.

According to an optional embodiment of the present disclosure, system 400 further includes monitoring module 403 configured to monitor status of one or more virtual storage pools in the virtual storage pool set; detecting module 404 configured to detect runtime events related to one or more virtual storage pools in the virtual storage pool set; and adjusting module 405 configured to adjust, on the basis of the status and the runtime events, the virtual storage pool set provided for the target application. Again monitoring module 403 and detecting module 404, can be combined into the optimization module 400, wherein the optimization module is configured to perform the tasks of these modules.

According to an optional embodiment of the present disclosure, the status comprises one or more of the following parameters: Quality of Service for one or more virtual storage pools in the virtual storage pool set for the target application, performance metrics for one or more virtual storage pools in the virtual storage pool set, physical resource utilization for one or more virtual storage pools in the virtual storage pool set, interactions and contentions between multiple virtual storage pools.

According to an optional embodiment of the present disclosure, the runtime events comprise changes of the target application and/or changes of the physical storage resources.

According to an optional embodiment of the present disclosure, the adjusting module (or the optimization module) adjusting the virtual storage pool set provided for the target application includes creating a new virtual storage pool in the virtual storage pool set, reclaiming an inactive virtual storage pool in the virtual storage pool set, or migrating workloads between multiple virtual storage pools in the virtual storage pool set.

According to an optional embodiment of the present disclosure, the adjustment made by adjusting module 405 to the virtual storage pool set is further based on input from a user. Adjusting Module 405, can be combined into the optimization module 400, wherein the optimization module is configured to perform the tasks of these modules.

According to an optional embodiment of the present disclosure, the performance requirements comprise one or more of the following parameters: capacity, cost, latency and input/output operations per second (IOPs).

Those skilled in the art may understand that the system for providing a virtual storage pool set for a target application as illustrated in FIG. 4 may be, for example, based on techniques like big data analytics, resource scheduling, runtime system monitoring and the likes. In particular, some existing system monitoring tools, like watch4net and ProSphere, can be utilized to realize VSP status monitoring. Some complex event processing (CEP) engines like Esper can be utilized to realize the runtime event detection. While constructing the VSP resource and workload manager, there are some existing system resource models or approaches, like Apache YARN, which can be utilized or referred to. Finally, system 400 will adopt techniques of big data analytics, data mining and machine learning. Those skilled in the art will understand that these concrete implementations are merely exemplary and do not limit the spirit and essence of the present disclosure.

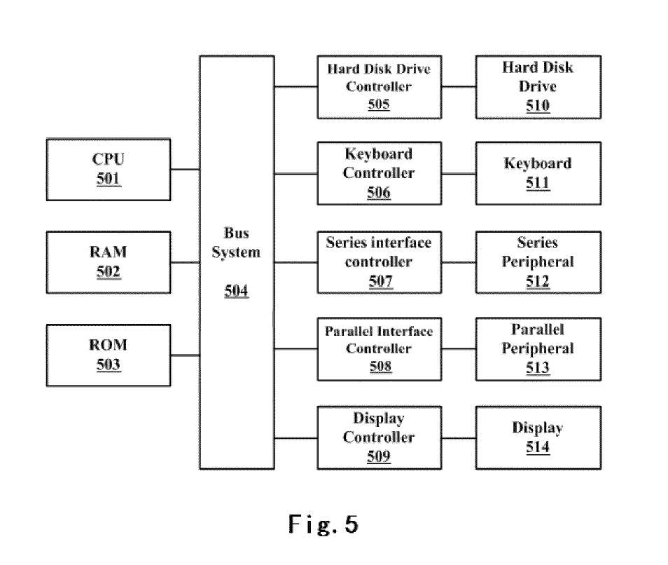

FIG. 5 illustrates an exemplary block diagram of a computer system that is applicable to implement the embodiments of the present disclosure. As shown in FIG. 5, the computer system may include: a CPU (Central Processing Unit) 501, a RAM (Random Access Memory) 502, a ROM (Read Only Memory) 503, a system bus 504, a hard disk controller 505, a keyboard controller 506, a serial interface controller 507, a parallel interface controller 508, a monitor controller 509, a hard disk 510, a keyboard 511, a serial peripheral device 512, a parallel peripheral device 513 and a monitor 514. Among these devices, connected to the system bus 504 are the CPU 501, the RAM 502, the ROM 503, the hard disk controller 505, the keyboard controller 506, the serial interface controller 507, the parallel interface controller 508 and the monitor controller 509. The hard disk 510 is coupled to the hard disk controller 505; the keyboard 511 is coupled to the keyboard controller 506; the serial peripheral device 512 is coupled to the serial interface controller 507; and the parallel peripheral device 513 is coupled to the parallel interface controller 508; and the monitor 514 is coupled to the monitor controller 509. In one embodiment the optimization module 400 could be embedded into the system 500 as a software module or a hardware module or a combination thereof.

It should be understood that the structural block diagram in FIG. 5 is shown only for illustration purpose, and is not intended to limit the scope of the present disclosure. In some cases, some devices may be added or reduced as required.

In particular, besides hardware embodiments, the embodiments of the present disclosure may also be implemented in a form of a computer program product. For example, the method as described with reference to FIGS. 1 to 3 may be implemented via a computer program product. This computer program product may be stored in RAM 502, ROM 503, hard disk 510 and/or any suitable storage medium as illustrated in FIG. 5, or downloaded to computer system 500 from a suitable location in the network. The computer program product may comprise computer code portions comprising program instructions that may be executed through a suitable processing device (for example, CPU 401 as shown in FIG. 5). The program instructions may at least include an instruction for receiving performance requirements associated with the target application; and an instruction for providing a virtual storage pool set for the target application according to the performance requirements and on the basis of storage capabilities of physical storage resources.

Illustration has been presented above to the spirit and principle of the present disclosure with reference to several concrete embodiments. According to the embodiment of the present disclosure, a logical storage block of appropriate size may be selected for a file according to the file's characteristics, and an on-demand physical storage area allocation may be adopted, so that fragments can be reduced without increasing metadata and location overhead and further a flexible and efficient management of file systems can be achieved.

It should be noted that, the embodiments of the present disclosure can be implemented in software, hardware or the combination thereof. The hardware part can be implemented by a dedicated logic; the software part can be stored in a memory and executed by a proper instruction execution system such as a microprocessor or a design-specific hardware. One of ordinary skill in the art may understand that the above-mentioned method and system may be implemented with a computer-executable instruction and/or in a processor controlled code, for example, such code is provided on a bearer medium such as a magnetic disk, CD, or DVD-ROM, or a programmable memory such as a read-only memory (firmware) or a data bearer such as an optical or electronic signal bearer. The apparatuses and their modules in the present invention may be implemented by hardware circuitry of a very large scale integrated circuit or gate array, a semiconductor such as logical chip or transistor, or a programmable hardware device such as a field-programmable gate array or a programmable logical device, or implemented by software executed by various kinds of processors, or implemented by combination of the above hardware circuitry and software such as firmware.

It should be noted that although a plurality of units or subunits of the apparatuses have been mentioned in the above detailed depiction, such partitioning is merely non-compulsory. In actuality, according to the embodiments of the present disclosure, the features and functions of two or more units above described may be embodied in one unit. On the contrary, the features and functions of one unit above described may be further partitioned to be embodied in more units.

In addition, although operations of the method of the present disclosure are described in specific order, it should not be construed as requiring or suggesting such operations be completed in the shown specific order, or as requiring all depicted operations to be executed for achieving desired results. On the contrary, the steps depicted in the flowchart may change execution order. Additionally or alternatively, some steps may be omitted, multiple steps may be combined to one step for execution, and/or one step may be decomposed into multiple steps for execution.

Although the present disclosure has been depicted with reference to a plurality of embodiments, it should be understood that the present disclosure is not limited to the embodiments disclosed herein. On the contrary, the present disclosure intends to cover various modifications and equivalent arrangements included in the spirit and scope of the appended claims. The scope of the appended claims meets the broadest explanations and covers all such modifications and equivalent structures and functions.

What is claimed is:

1. A method for providing a virtual storage pool for a target application, the method comprising:
receiving performance requirements associated with a target application; and
providing a virtual storage pool set for the target application in accordance with the performance requirements received and based on a storage capability associated with a plurality of physical storage resources, the virtual storage pool set comprising one or more virtual storage pools.

2. The method according to claim 1, wherein the step of providing a virtual storage pool set for the target application in accordance with the performance requirements received and based on a storage capability associated with a plurality of physical storage resources further comprises:
building a performance prediction model based on historical data of one or more historical target applications, the historical data comprising a virtual storage pool set provided for each of the one or more historical target applications, and the corresponding performance obtained;
generating one or more alternative virtual storage pool sets for the target application in accordance with the performance requirements and based on a storage capability associated with a physical storage resources;
respectively predicting performance of the one or more alternative virtual storage pool sets using the performance prediction model; and
selecting, based on the prediction, one alternative virtual storage pool set from the one or more alternative virtual storage pool sets to be provided to the target application.

3. The method according to claim 2, further comprising:
monitoring status of one or more virtual storage pools in the virtual storage pool set;
detecting runtime events related to one or more virtual storage pools in the virtual storage pool set; and
adjusting, based on the status and the runtime events, the virtual storage pool set provided for the target application.

4. The method according to claim 3, wherein the status comprises one or more of parameters:
Quality of Service of one or more virtual storage pools in the virtual storage pool set for the target application;
performance metrics of one or more virtual storage pools in the virtual storage pool set;
physical resource utilization of one or more virtual storage pools in the virtual storage pool set;
interactions; and
contentions between multiple virtual storage pools.

5. The method according to claim 3, wherein the runtime events comprise at least one of changes of the target application and changes of the physical storage resources.

6. The method according to claim 3, wherein the step of adjusting the virtual storage pool set provided for the target application comprises:
creating a new virtual storage pool in the virtual storage pool set;
reclaiming an inactive virtual storage pool in the virtual storage pool set; or
migrating workloads between multiple virtual storage pools in the virtual storage pool set.

7. The method according to claim 3, wherein the adjustment to the virtual storage pool set is further based on input from a user.

8. The method according to claim 2, wherein the performance requirements comprise one or more of following parameters: capacity, cost, latency and a number of input/output operations per second (IOPs).

9. A system for providing a virtual storage pool for a target application, the system comprising:
an optimization module configured to
receive performance requirements associated with a target application; and
virtual storage pool providing module configured to provide a virtual storage pool set for the target application in accordance with the performance requirements and based on a storage capability associated with a plurality of physical storage resources, the virtual storage pool set comprising one or more virtual storage pools.

10. The system according to claim 9, further configured to:
build a performance prediction model based on historical data of one or more historical target applications, the historical data comprising a virtual storage pool set provided for each of the one or more historical target applications, and the corresponding performance obtained;
generate one or more alternative virtual storage pool sets for the target application in accordance with the performance requirements and based on the storage capability of the plurality of physical storage resources;
predict performance of the one or more alternative virtual storage pool sets using the performance prediction model; and
selecting module configured to select, based on the prediction, one alternative virtual storage pool set from the one or more alternative virtual storage pool sets so as to be provided to the target application.

11. The system according to claim 10, further configured to:
monitor status of one or more virtual storage pools in the virtual storage pool set;
detect runtime events related to one or more virtual storage pools in the virtual storage pool set; and
adjust, based on the status and the runtime events, the virtual storage pool set provided for the target application.

12. The system according to claim 11, wherein the status comprises one or more of parameters:
Quality of Service of one or more virtual storage pools in the virtual storage pool set for the target application;
performance metrics of one or more virtual storage pools in the virtual storage pool set;
physical resource utilization of one or more virtual storage pools in the virtual storage pool set;
interactions; and
contentions between multiple virtual storage pools.

13. The system according to claim 11, wherein the runtime events comprise at least one of changes of the target application and changes of the physical storage resources.

14. The system according to claim 11, wherein an adjusting module adjusting the virtual storage pool set provided for the target application comprises:
creating a new virtual storage pool in the virtual storage pool set;
reclaiming an inactive virtual storage pool in the virtual storage pool set; or
migrating workloads between multiple virtual storage pools in the virtual storage pool set.

15. The system according to claim 11, wherein the adjustment made to the virtual storage pool set is based on input from a user.

16. The system according to claim 10, wherein the performance requirements comprise one or more of parameters: capacity, cost, latency and a number of input/output operations per second (IOPs).

17. A computer program product for providing a virtual storage pool for a target application, the computer program product being tangibly stored in a non-transient computer readable medium and including machine executable instructions, the machine executable instructions, when being executed, causing a machine for
receiving performance requirements associated with a target application; and
providing a virtual storage pool set for the target application in accordance with the performance requirements received and based on a storage capability associated with a plurality of physical storage resources, the virtual storage pool set comprising one or more virtual storage pools.

18. The computer program product according to claim 17, wherein the step of providing a virtual storage pool set for the target application in accordance with the performance requirements received and based on a storage capability associated with a plurality of physical storage resources further comprises:
building a performance prediction model based on historical data of one or more historical target applications, the historical data comprising a virtual storage pool set provided for each of the one or more historical target applications, and the corresponding performance obtained;
generating one or more alternative virtual storage pool sets for the target application in accordance with the performance requirements and based on a storage capability associated with a physical storage resources, wherein the performance requirements comprise one or more of following parameters: capacity, cost, latency and a number of input/output operations per second (IOPs);
respectively predicting performance of the one or more alternative virtual storage pool sets using the performance prediction model; and
selecting, based on the prediction, one alternative virtual storage pool set from the one or more alternative virtual storage pool sets to be provided to the target application.

19. The computer program product according to claim 18, further comprising:
monitoring status of one or more virtual storage pools in the virtual storage pool set;
detecting runtime events related to one or more virtual storage pools in the virtual storage pool set; and
adjusting, based on the status and the runtime events, the virtual storage pool set provided for the target application.

20. The computer program product according to claim 19, wherein the status comprises one or more of the following parameters:
Quality of Service of one or more virtual storage pools in the virtual storage pool set for the target application;
performance metrics of one or more virtual storage pools in the virtual storage pool set;
physical resource utilization of one or more virtual storage pools in the virtual storage pool set;
interactions; and
contentions between multiple virtual storage pools; and
wherein the runtime events comprise at least one of changes of the target application and changes of the physical storage resources; and wherein the step of adjusting the virtual storage pool set provided for the target application comprises:
creating a new virtual storage pool in the virtual storage pool set;
reclaiming an inactive virtual storage pool in the virtual storage pool set; or
migrating workloads between multiple virtual storage pools in the virtual storage pool set; and wherein the adjustment to the virtual storage pool set is further based on input from a user.
